(19) United States
(12) Patent Application Publication
(10) Pub. No.: US 2025/0261807 A1
(43) Pub. Date: Aug. 21, 2025

(54) AUTOMATIC FLUID DISPENSER

(71) Applicant: Machan Investments LLC, Gardena, CA (US)

(72) Inventors: Ash Asela Desilva, Long Beach, CA (US); Anuradha Andy De Silva, Ranchos Palos Verdes, CA (US); Shehan James, Los Angeles, CA (US); Dinesh Weerasekera, Fullerton, CA (US)

(21) Appl. No.: 18/443,844

(22) Filed: Feb. 16, 2024

(51) Int. Cl. A47K 5/12

(52) U.S. Cl. CPC A47K 5/1207; A47K 5/1217

(57) ABSTRACT

A dispenser has a housing case that defines a storage chamber, and a container inserted into the storage chamber of the housing case. A pump dispenser is mounted on a neck of the container for pumping liquid out of the container. A pump head moves between a raised position and a lowered position for dispensing the liquid out a first outlet tube that extends laterally to an outlet port. A receiver head having an opening is adapted to receive the first outlet tube, the receiver head being operably attached to a second outlet tube, the second outlet tube having a top end attached to the receiver head, and a bottom end. The dispenser further includes a pumping means for pushing the pump head of the container to the lowered position, against the bias of the at least one spring, in response to a sensing means.

### BACKGROUND OF THE INVENTION

### Field of the Invention

This invention relates generally to fluid dispensers, and more particularly to an automatic fluid dispenser that dispenses fluids, in particular personal case fluids such as shampoo, conditioner, soap, and other similar products.

### Description of Related Art

The prior art teaches a wide range of dispensers for dispensing fluids such as shampoo, conditioner, soap and similar products. An example of a standard liquid soap dispenser is shown in Copeland, U.S. Pat. No. 5,9102,698. This reference teaches a housing to hold a container of soap in an upright configuration, with a pump actuator at the top for dispensing the soap. This reference teaches manual actuation of the pump mechanism, and the product is dispensed from the front top of the dispenser.

Muderlak, U.S. Pat. No. 5,823,390, teaches a dispensing apparatus that houses containers of liquids such as chemicals used for deodorizing and disinfecting toilets. The dispensing apparatus includes an actuator system that includes an actuator nozzle has a receiving aperture and a dispensing aperture where the receiving aperture is operatively coupled to the vessel to receive the chemicals contained within the vessel. The dispensing aperture is coupled to the receiving aperture and is also connected to a conveying tube to direct the chemical from the vessel, through the tube and into a chemical receiving receptacle. Also included is a structure for ejecting the chemical from the vessel into the actuator nozzle. The actuator nozzle remains in an upward and outwardly pivoted position when the vessel is disengaged from the actuator nozzle to facilitate reengagement of the vessel with the actuator nozzle. Muderlak relies upon a spring (190, shown in FIG. 3) that is built into the pump actuator, and does not include an exterior spring to raise the pump mechanism between pumps.

O'Maley, U.S. Pat. No. 6,431,400, teaches a dispenser apparatus for dispensing a liquid product like soap. A container of soap is inserted into a housing case. The container has an exit port at the bottom, so it is dispensed from an upside-down configuration. A chute directs the flow of the discharged product. A drive assembly causes the product to move from the container through the chute to be dispensed therefrom. A magnetic sensor is attached to a support surface of the housing case, and a wafer is attached to the container. The wafer has a magnet embedded therein, and the container is inserted into the housing case so that the wafer is received by and mates with the housing case to align the magnet with the magnetic sensor. A location of the magnet embedded in the wafer of the container is detected by the magnetic sensor of the housing case so that the container is identified. The drive means is only activated when the container is identified as an authorized container based on the location of the magnet. A similar soap dispenser that holds the soap container upside down for dispensing is also shown in Mease, U.S. Pat. No. 5,186,360.

Liao, U.S. 20110095051, teaches an automatic foam soap dispenser used for soap reservoir. The soap reservoir is maintained in an upright orientation. The automatic foam soap dispenser includes a covering housing, a control circuit board, a motor, and a sensor. The soap reservoir has a pressing head at the top thereof, the pressing head is communicated with a connecting head, and the connecting head has an extension pipe to communicate with a foam nozzle.

### SUMMARY OF THE INVENTION

The present invention teaches certain benefits in construction and use which give rise to the objectives described below.

The present invention provides a dispenser for dispensing a liquid. The dispenser comprises a housing case that defines a storage chamber, and a container inserted into the storage chamber of the housing case. The container has a base and a sidewall that extends upwardly to a neck that defines a top opening (best shown in FIG. 4), which together form a liquid storage compartment for storing the liquid. A pump dispenser is mounted on the neck of the container, covering the top opening, for pumping the liquid out of the container, the pump dispenser having a tube that extends downwardly into the liquid storage compartment of the container, and a pump head that moves between a raised position and a lowered position for dispensing the liquid out a first outlet tube that extends laterally to an outlet port. A receiver head having an opening is adapted to receive the first outlet tube of the pump dispenser, the receiver head being operably attached to a second outlet tube, the second outlet tube having a top end attached to the receiver head, and a bottom end. The dispenser further includes a pumping means for pushing the pump head of the container to the lowered position, against the bias of the at least one spring, in response to a sensing means.

A primary objective of the present invention is to provide an automatic dispenser having advantages not taught by the prior art.

Another objective is to provide an automatic dispenser that is adapted to receive a liquid container with a standard upper pump mechanism that is located at the top of the container, so that it remains upright and cannot leak, and wherein the automatic dispenser includes a fluid flow network that dispenses the liquid (soap) at a bottom of the automatic dispenser responsive to a motion sensor.

A further objective is to provide a dispenser that utilizes an RFID chip and reader for recognizing the type of liquid container in the automatic dispenser.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is an exploded perspective view of an automatic dispenser according to one embodiment of the present invention;

FIG. 2 is a perspective view of the automatic dispenser of FIG. 1 once it has been assembled, the automatic dispenser being shown with a cover open and a container being inserted into a housing case;

FIG. 3 is a perspective view of the housing case, with the container removed for clarity, and also illustrating how the cover mounts onto the housing case; and

FIG. 4 is a cross sectional side elevation view of the container mounted in the housing case;

FIG. 5 is a cross-section of a lower portion of the automatic dispenser, illustrating an RFID chip in the container, and a sensor assembly in the housing case.

### DETAILED DESCRIPTION OF THE INVENTION

The above-described drawing figures illustrate the invention, a wall mounted automatic dispenser for dispensing liquids such as shampoo, conditioner, soap, oils, lotion, etc., and any other such liquids that a user might want to dispense.

For purposes of this application, the term “container” is broadly defined to include any form of bottle, flask, bowl, receptacle, canister, cartridge, or other structure known in the art for containing and dispensing a liquid. The term “liquid product” is also broadly defined to include any form of liquid product, such as soap, lotion, shampoo, conditioner, or any other similar product known in the art.

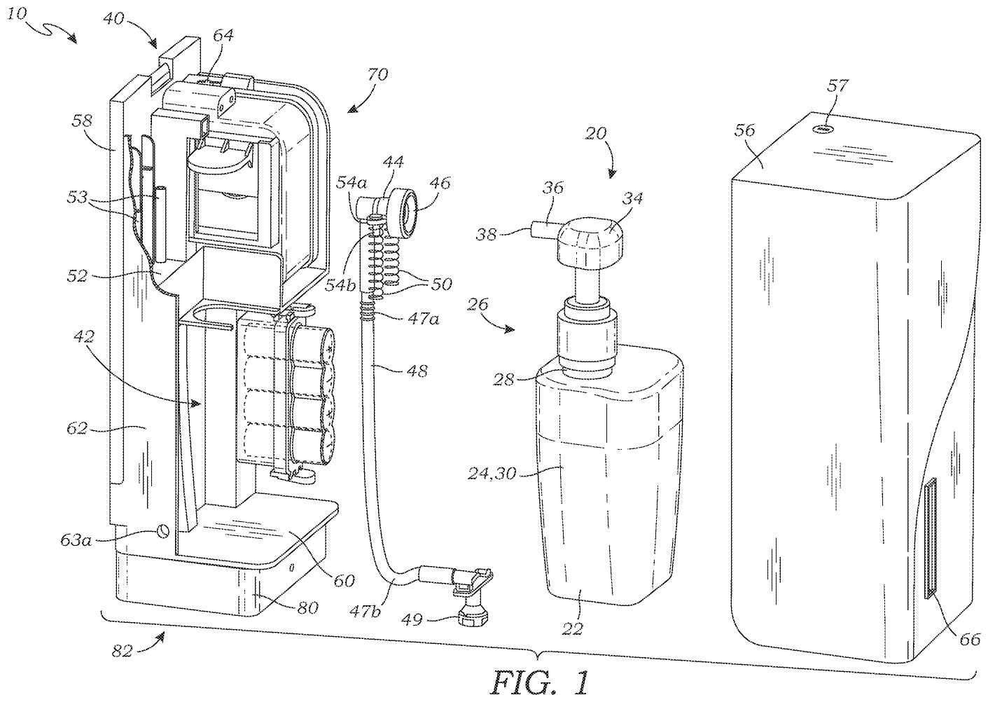

FIG. 1 is an exploded perspective view of an automatic dispenser 10 according to one embodiment of the present invention. As shown in FIG. 1, the invention includes a housing case 40 that is adapted to contain at least one container 20 of a liquid product (e.g., shampoo, soap, conditioner, lotion, etc.), wherein the container 20 can be taken out for filling and replaced in an upright position. The container 20 may be easily removed and refilled, or replaced with a new, different container. While only one container is shown and described in this application, the housing case 40 may be adapted to contain multiple containers at once, such as for example, a container of shampoo, a container of conditioner, and a container of body wash, and such alternatives should be considered within the scope of the present invention.

In standard use, as discussed in greater detail below, the automatic dispenser 10 is actuated by a sensing means 82 such that the liquid product 12 travels from an upper pump dispenser 26 of the container 20, through a conduit network, and out of a lower liquid outlet 49 of housing case 40.

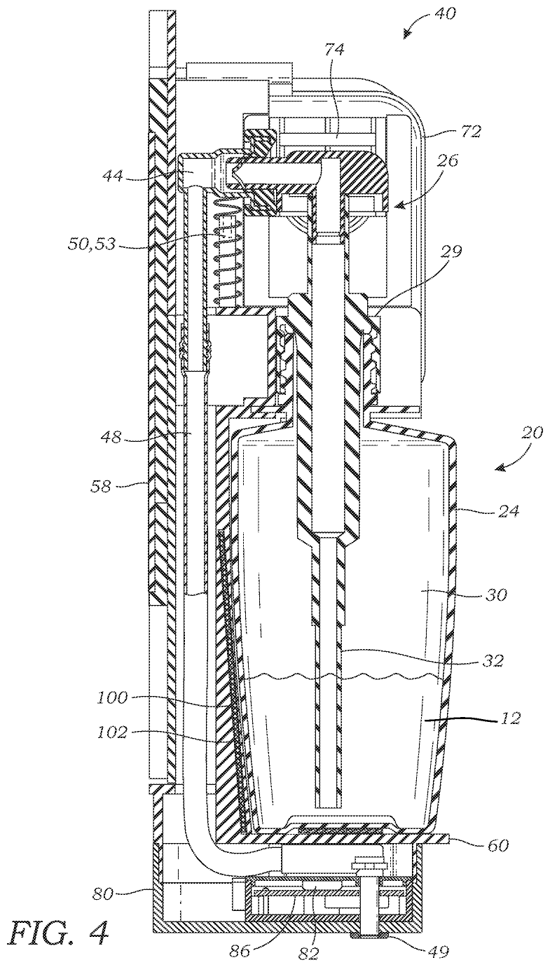

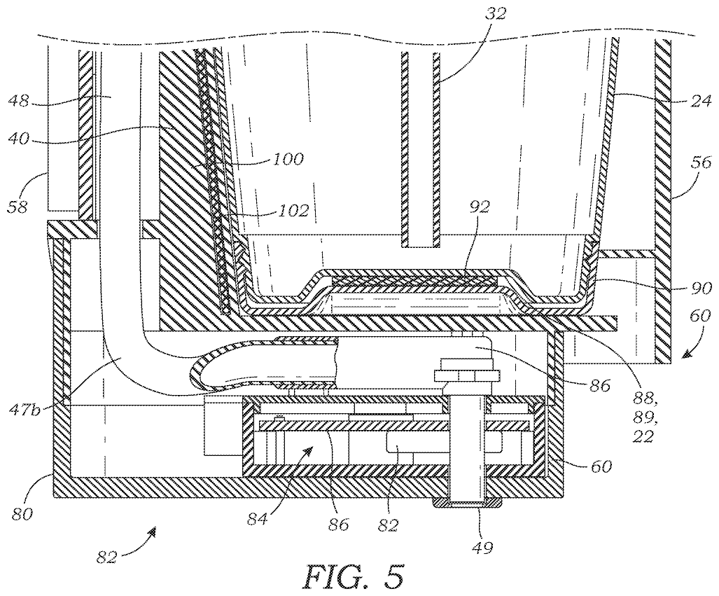

In this embodiment, the container 20 comprises a base 22, and a sidewall 24 that extends upwardly to a neck 28 that defines a top opening 29, which together form a liquid storage compartment 30 for storing the liquid. In the embodiment of FIG. 1, the container 20 has a generally rectangular cross-section, but in other embodiments, the container 20 may have any other shape, such as a cylindrical shape, or any other suitable shape for containing the liquid. The container 20 may be of any standard construction known in the art adapted to contain soap, lotion, shampoo, etc., although any desired liquids may be dispensed, so the examples listed herein should not be considered limiting. As illustrated, the pump dispenser 26 is mounted on the neck 28 of the container 20, covering the top opening 29, for pumping the liquid out of the container 20. The pump dispenser 26 has a tube 32 (shown in FIGS. 4-5) that extends downwardly into the liquid storage compartment 30 of the container 20, and a pump head that moves between a raised position and a lowered position for dispensing the liquid out of a first outlet tube 36 36 that extends laterally to an outlet port 38.

As shown in FIG. 1, the housing case 40 defines a storage chamber 42 that is shaped so that the container 20 may be inserted into and stored within the storage chamber 42. The storage chamber 42 contains a receiver head 44 that is adapted to engage the pump of the container. The receiver head 44 has an opening 46 adapted to receive the first outlet tube 36 36 of the pump dispenser 26, so that the fluid flowing out of the first outlet tube 36 flows into the receiver head.

The receiver head 44 is operably attached to a second outlet tube 48 that extends downwardly to the liquid outlet 49. In this embodiment, the second outlet tube 48 having a top end 47a attached to the receiver head 44, and a bottom end 47b that extends downwardly to the liquid outlet 49, discussed in further detail below. In various embodiments, the receiver head 44 is formed with an inlet check valve which prevents liquid product 12 from backing out into the outlet port 38 of the pump dispenser 26, and also prevents liquid from backing out when the container 20 is removed from the storage chamber 42. Alternative structures may be implemented for preventing backflow of the liquid product 12, e.g., resilient molding inside the opening 46 of the receiver head 44 that closes when the first outlet tube 36 is removed, or similar structures. Furthermore, a similar mechanism may be included in the liquid outlet 49, to prevent unwanted drip of liquid product 12.

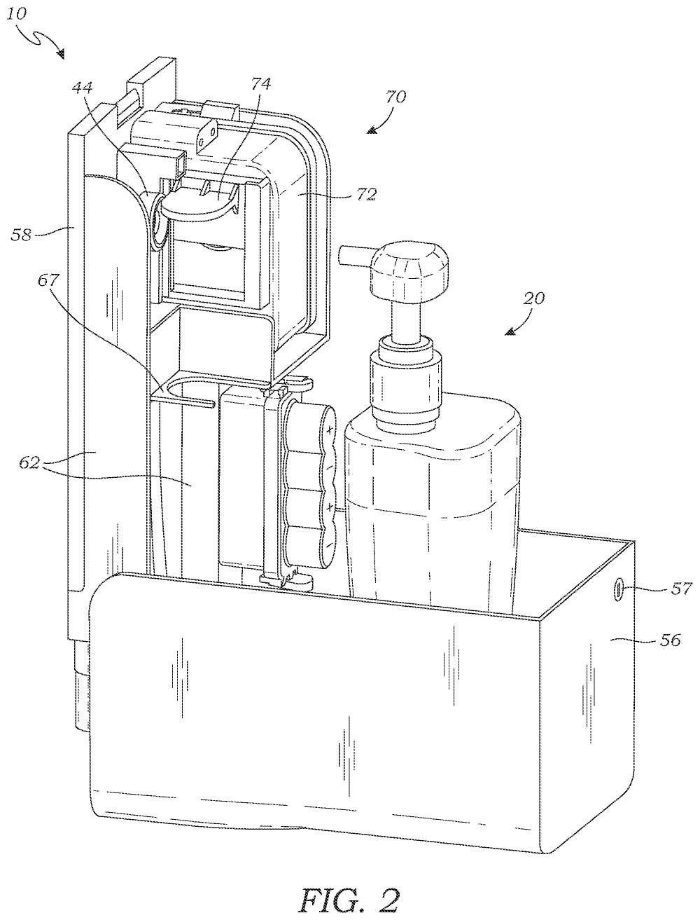

As illustrated, at least one spring 50 is positioned beneath the receiver head 44, in this embodiment a pair of springs, wherein a support platform 52 of the housing case 40 includes spring mounting points 53 for receiving the springs 50. In an assembled configuration (FIGS. 2-4), the springs 50 are positioned between the receiver head 44 and the support platform 52 on the spring mounting points 53, for biasing the receiver head 44 upwardly, thereby biasing the pump head 34 toward a raised position. In one embodiment, the springs 50 are operably attached to the receiver head 44 via a pin receiver 54a and pin 54b. In this embodiment, two springs 50 bias the receiver head 44 upwardly, but any suitable number of springs may be included, and they may be connected to the receiver head 44 via any suitable means of attachment. Further details of the housing case 40 are discussed below.

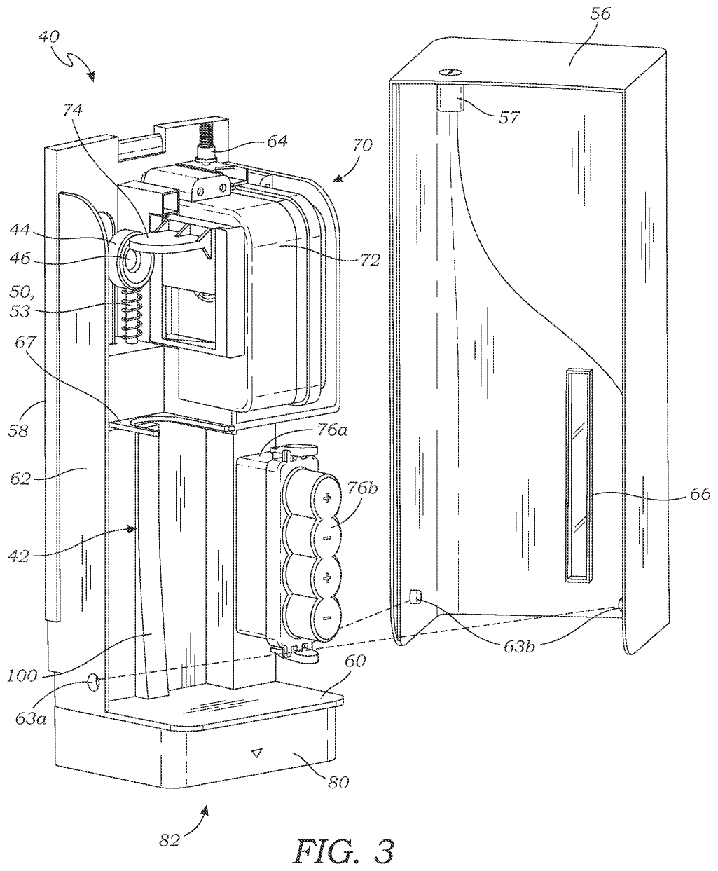

FIG. 2 is a perspective view of the automatic dispenser 10 once it has been assembled, shown with a cover 56 open and the container 20 being inserted into the storage chamber 42. FIG. 3 is a perspective view of the housing case 40, with the container 20 removed for clarity, and also illustrating how the cover 56 mounts onto the housing case 40. The cover 56 may be locked with a locking mechanism 57 that may be unlocked with a magnetic key (not shown), a mechanism well known in the art of this type of product.

As shown in FIGS. 1-3, in this embodiment, the housing case 40 comprises a rear wall plate 58 that may be attached to a vertical surface (not shown) via any suitable means of attachment, e.g., mechanical fasteners such as screws, bolts, hooks, slide rails, and such, or non-mechanical fasteners such as an adhesive, suction cups, magnets, hook-and-loop strips, etc. The wall plate 58 supports the rest of the components of the housing case 40 on the vertical surface (i.e., a wall).

In this embodiment, a lower portion 60 of the housing case 40 is in the form of a lower platform 60 extends forward from the bottom of the wall plate 58, wherein the lower platform 60 supports the container 20 when the container 20 is inserted into the storage chamber 42. A sensor housing 80 is positioned beneath the lower platform 60 for housing the sensing means 82 and the liquid outlet 49, best shown in FIGS. 4-5 and discussed further below. In alternative embodiments, the lower portion 60 may include additional structures other than the lower platform 60. In this embodiment, a pair of sidewalls 62 also extend forward from the rear wall plate 58 on either side of the rear wall plate 58.

As shown, the pair of sidewalls 62 may each include a hinge aperture 63a for receiving hinge pins 63b of the cover 56 (FIG. 3), so that the cover 56 may attach to the sidewalls 62 and hinge downwardly for removing/replacing the container 20 (FIG. 2). However, in other embodiments, the cover 56 may hinge in a different direction, or it may be removably attached via another means, e.g., be fully removable via a press-release button, switch, or similar mechanism. The cover 56 may be locked and unlocked in the closed position via a key (not shown), wherein the key may include at least one magnet for retracting at least one locking post 64. Since this type of locking mechanism is well known in the art, it is not described in further detail herein. Furthermore, in alternative embodiments, the cover 56 may be locked in place via a different mechanism, e.g., via a turn-key, or any other suitable locking means. As shown in FIGS. 1 and 3, the cover 56 may also include a window 66 positioned adjacent the sidewall 24 of the container 20 when the container 20 is within the storage chamber 42, so that the level of remaining liquid product 12 inside the container 20 may be seen without having to open the cover 56.

As illustrated, a stabilizing structure 67 may be included in the storage chamber 42, adapted to extend on either side of the neck 28 of the container 20 when the container 20 is positioned in the storage chamber 42, which may help with correctly positioning the container 20 so that unwanted shifting does not occur. In alternative embodiments, the stabilizing structure 67 may be formed to abut a different part of the container 20, and many other similar stabilizing structures may otherwise be implemented. In further alternatives, the stabilizing structure 67 may be excluded entirely.

As shown in FIGS. 1-3, the housing case 40 includes a pumping means 70 located between the sidewalls 62 for pushing the pump head 34 of the container 20 to the lowered position, against the bias of the at least one spring 50, in response to the sensing means 82. The pumping means 70 may include an assembly housing 72 that houses a gearbox assembly (not shown) that is actuated by the sensing means 82. In this embodiment, the sensing means 82 is in the form of a motion sensor; however, other forms of sensors known in the art may be used (e.g., touch sensor, heat sensor, other form of electromagnetic sensors known in the art, etc.).

When actuated, the gearbox assembly rotates to move an upper platform 74 of the pumping means 70 from a raised position to a lowered position. The spring 50 or springs discussed above assist in the receiver head 44 (and the upper platform 74) being returned back to the raised position. In this manner, the upper platform 74 functions to pump liquid out of the container 20 and into the receiver head 44 and second outlet tube 48. In alternative embodiments, the pumping means 70 may include mechanisms other than a gear box, which may be any means known in the art for moving the upper platform 74 from the raised position to the lowered position, and back to the raised position.

As illustrated in FIG. 3, a battery housing 76a with a battery cover 76b may be positioned beneath the assembly housing 72 for supplying power to the automatic dispenser 10. However, the batteries may be positioned elsewhere in/on the housing case 40, or the automatic dispenser 10 may include a different form of power source (e.g., a wired connection to a power outlet or external battery, solar power, etc.).

FIG. 4 is a cross sectional side elevation view of the container 20 mounted in the housing case 40. FIG. 4 illustrates the top opening 29 of the container 20, the pair of springs 50 mounted on the spring mounting points 53, and also shows the first outlet tube 36 of the pump dispenser 26 operably connected to the opening 46 of the receiver head 44 of the storage chamber 42. The second outlet tube 48 extends downwardly from the receiver head 44 and into the sensor housing 80, wherein the liquid outlet 49 is positioned beneath the sensor housing 80. Liquid 12 in the container 20 is thus directed to the liquid outlet 49 in the bottom of the system.

FIG. 5 is a cross-section of a lower portion 60 of the automatic dispenser 10, illustrating an RFID tag 92 in the container 20, and a sensor assembly 84. As shown in FIGS. 4-5, the sensor assembly 84 is mounted on the lower portion 60 of the housing case 40, beneath the container 20 once the container 20 has been inserted into the storage chamber 42 of the housing case 40. In this embodiment, the sensor assembly 84 includes the sensing means 82 that senses motion of a user within a preset radius, and communicates with the pumping means 70 to operate the automatic dispenser 10; and a reader module 86 that reads the RFID tag 92 of the container 20. In this embodiment, the sensing means 82 is in the form of an infrared sensor. In other embodiments, the sensing means 82 may instead be a microwave sensor, an ultrasonic sensor, a dual sensor, or other motion sensing technology. Since this type of sensor is well-known in the art, it is not discussed further herein.

As shown in FIG. 5, in some embodiments, the RFID tag 92 is operably mounted on the bottom of the container. In this embodiment, it is mounted in a recess 88 of a bottom surface 89 of the container 20. In this embodiment, the container 20 may further include a bottom cap 90 that covers the RFID tag 92, to protect the tag from damage. The cap 90 may be mounted via a threaded connection, a frictional engagement, adhesive or thermal welding, or other means known in the art.

A reader module 86 is positioned beneath the RFID tag 92 when the container is in the housing, such as in/on the sensor housing 80, or other suitable structures in this portion of the device. In this embodiment, the reader module 86 is an induction reader for inductively reading the RFID tag 92. The reader module 86 may be operably connected with any form of electronics, communications, and other electronics for reporting information from the RFID tag 92. The reader module 86 senses the RFID tag 92 to detect the type of container 20 that has been inserted into the storage chamber 42. If the container 20 does not have an RFID tag 92, the reader module 86 may block the automatic dispenser 10 from operating. In one embodiment, such as in the instance of multiple containers being inserted into the housing case 40, the reader module 86 may determine from which container 20 liquid product 12 is dispensed, and/or out of which liquid outlet 49 it is dispensed, in the case of multiple liquid outlets. For example, there may be a mechanism for selecting the desired liquid product to be dispensed prior to motion sensing for dispensing (e.g., a button selection or similar).

As shown in FIGS. 4-5, the housing case 40 of the system may further include a sensing strip 100 (also shown in FIG. 3) that includes a level detection reader 102. The sensing strip 100 extends outwardly to abut the container, so that the level detection reader 102 is able to sense the fluid level in the container. In this embodiment, the level detection reader 102 is in the form of a PCB circuit board located between the wall plate 58 of the dispenser housing and the container 20, above the lower platform/lower portion 60, so that it is able to detect (e.g., inductively or otherwise) the level of the liquid product 12 inside the liquid storage compartment 30. This solves the problem of having to open the cover 56 in order to check the remaining amount of liquid product 12, and makes it possible to check the liquid condition of one or more machines at any time and prepare the amount of liquid to be replaced in advance, thus improving the efficiency of the work.

In use, the cover 56 of the housing case 40 is unlocked and hinged open, and the container 20 is inserted into the storage chamber 42 and connected to the receiver head 44 (as shown in FIG. 4). The reader module 86 is then able to read the RFID tag 92 of the container 20 to determine if it is an approved container 20, if it is in the correct slot (if there are multiple containers in a single housing), what liquid is in the container, where it was purchased, when, and any other details regarding the container that may be desired to be tracked and monitored.

The level detection reader 102 is also able to detect the the level of liquid product within the container 20 (a user can also visually see the level of liquid product 12 via the window 66 on the cover 56). The RFID information, and the information about the level of liquid in the container, is able to be transmitted (e.g., Bluetooth®, or any other wired or wireless connection) to a monitoring computer (e.g., smart phone or tablet computer with a suitable app, etc.), so that when the liquid product 12 reaches a certain level, a maintenance person can be alerted to refill or replace the container. This can be done by opening the cover 56 via the key (e.g., typically a magnetic device) and remove the container 20, wherein the an inlet check valve (or similar) prevents backflow of the liquid product 12 out of the receiver head 44. The container 20 can then either be refilled, or replaced with a new container, and the entire process repeats as necessary.

While in use, the sensing means 82 is able to detect motion (or other signal or triggering mechanism) to actuate the pumping means 70 to pump the pump dispenser 26 of the container 20, so that the liquid product 12 travels from the liquid storage compartment 30, into the receiver head 44, down the second outlet tube 48, and out of the liquid outlet 49.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A dispenser for dispensing a liquid, the dispenser comprising:
a housing case that defines a storage chamber;
a container inserted into the storage chamber of the housing case, the container having a base, and a sidewall that extends upwardly to a neck that defines a top opening, which together form a liquid storage compartment for storing the liquid;
a pump dispenser mounted on the neck of the container, covering the top opening, for pumping the liquid out of the container, the pump dispenser having a tube that extends downwardly into the liquid storage compartment of the container, and a pump head that moves between a raised position and a lowered position for dispensing the liquid out a first outlet tube that extends laterally to an outlet port;
a receiver head having an opening adapted to receive the first outlet tube of the pump dispenser, the receiver head being operably attached to a second outlet tube, the second outlet tube having a top end attached to the receiver head, and a bottom end;
a sensing means for sensing motion beneath the housing case; and
a pumping means for pushing the pump head of the container to the lowered position, against the bias of the at least one spring, in response to the sensing means.

2. The dispenser of claim 1, wherein the sensing means includes a motion sensor.

3. The dispenser of claim 1, wherein the pumping means includes:
an assembly housing that houses a gearbox assembly that is actuated by the sensing means;
wherein the gearbox assembly rotates to move an upper platform of the pumping means from a raised position to a lowered position, and then back to the raised position, when actuated; and
wherein the upper platform abuts the top of the pump head of the container when the container is within the storage chamber, such that the upper platform functions to pump the liquid product out of the container and into the receiver head.

4. The dispenser of claim 1, further comprising:
an RFID tag operably mounted in a recess of a bottom surface of the container; and
a sensor assembly mounted on a bottom portion of the housing case, beneath the container once the container has been inserted into the storage chamber of the housing case.

5. The dispenser of claim 4, wherein the RFID tag is read by a reader module of the sensor assembly to determine the type of liquid product within the container when it is within the storage chamber of the housing case.

6. A dispenser for dispensing a liquid, the dispenser comprising:
a housing case that defines a storage chamber;
a container inserted into the storage chamber of the housing case, the container having a base, a sidewall that extends upwardly to a neck that defines a top opening, which together form a liquid storage compartment for storing the liquid;
a pump dispenser mounted on the neck of the container, covering the top opening, for pumping the liquid out of the container, the pump dispenser having a tube that extends downwardly into the liquid storage compartment of the container, and a pump head that moved between a raised position and a lowered position for dispensing the liquid out an outlet tube that extends laterally to an outlet port;
a receiver head having an opening adapted to receive the outlet tube of the pump dispenser, the receiver head being operably attached to the outlet tube, the outlet tube having a top end attached to the receiver head, and a bottom end;
at least one spring positioned between the receiver head and a support platform of the housing case, for biasing the receiver head upwardly, thereby biasing the pump head toward the raised position;
a sensing means for sensing motion beneath the housing case; and
a pumping means for pushing the pump head of the container to the lowered position, against the bias of the at least one spring, in response to the sensing means.
